(19) United States
(12) Patent Application Publication
(10) Pub. No.: US 2024/0338911 A1
(43) Pub. Date: Oct. 10, 2024

(54) AUGMENTED REALITY VISUALIZATION EMBARKATION METHOD AND SYSTEM

(71) Applicant: THE UNITED STATES OF AMERICA, AS REPRESENTED BY THE SECRETARY OF THE NAVY, Arlington, VA (US)

(72) Inventor: Brian T. Pugh, Suffolk, VA (US)

(21) Appl. No.: 18/745,884

(22) Filed: Jun. 17, 2024

Related U.S. Application Data
(60) Provisional application No. 63/521,607, filed on Jun. 16, 2023.

(51) Int. Cl. G06T 19/00; G01S 17/89

(52) U.S. Cl. CPC G06T 19/006; G01S 17/89; G06T 2210/21

(57) ABSTRACT

A method and system of generating embarkation files for packing a container. The method and system including a Light Detection and Ranging (LiDAR) scanner to scan objects to be packed into a container and generate a digital twin of each scanned object; generating an embarkation data file including embarkation data required for shipping the equipment set, processing the embarkation data file using a 3D bin packing algorithm configured to provide a packing solution to optimally pack all the objects of the equipment set in one or more customizable container configurations, and using an augmented reality (AR) computer tablet and/or AR headset, and performing a digital pack out of the associated equipment set; and the user exporting to the embarkation system a final 3D map of the location of each object of the equipment set within the container to be used for an actual physical pack out of the associated equipment.

### CROSS REFERENCE TO RELATED PATENT(S) AND APPLICATION(S)

This application claims the benefit of U.S. Provisional Application No. 63/352,107 filed Jun. 16, 2022, and entitled Logistics and Embarkation in Virtual Environment with Augmented Reality, which is hereby incorporated in its entirety by reference.

### BACKGROUND

This disclosure, and the example embodiments described herein, describe augmented reality visualization embarkation methods and systems for a user or packer to pack a container including a plurality of objects in preparation of an embarkation, however it is to be understood that the scope of this disclosure is not limited to such application. According to an example embodiment described, the methods and systems are implemented in an embarkment exercise or operation associated with the deployment of a group of military personnel and their equipment, however the application of the described methods and systems are also applicable to the embarkment of other groups and their associated equipment, provisions, personal items, etc.

### BRIEF DESCRIPTION

In accordance with one example embodiment of the present disclosure, disclosed is a method of generating embarkation files used by a 3D augmented reality visualization embarkation system for a user to pack a container including a plurality of objects, the method comprising: using a Light Detection and Ranging (LiDAR) scanner, scanning objects of an equipment set to be packed into the container and generating a digital twin of each scanned object; storing in a digital twin database the generated digital twin data of each object of the equipment set; generating an embarkation data file including embarkation data required for shipping the equipment set, the embarkation data file including embarkation data associated with the equipment set and digital twin data representations of each of the objects included in the equipment set, the embarkation data file having a format that is useable by a program for manual viewing and manual editing; processing the embarkation data file using a 3D bin packing algorithm configured to provide a packing solution to optimally pack all the objects of the equipment set in one or more customizable container configurations, the packing solution including the location of each object in the one or more customizable container configurations which 1) maximizes a number of objects packed within the one or more customizable container configurations and/or 2) maximizes a number of priority objects packed within the one or more customizable container configurations, the number of priority objects less than a total number of objects included in the equipment set; loading the embarkation data files and associated digital twin data representations onto a network server or stand-alone computer; using an augmented reality (AR) computer tablet and/or AR headset, a user accessing the embarkation data files and associated digital twin data representations to perform a digital pack out of the associated equipment set, wherein the user views and modifies, if necessary, a 3 dimensional (3D) map of the location of each object of the equipment set within the container; and the user exporting to the embarkation system a final 3D map of the location of each object of the equipment set within the container and exporting any modified embarkation data files and any modified associated digital twin data representations to the embarkation file database and digital twin database, respectively.

In accordance with another example embodiment of the present disclosure, disclosed is a 3D augmented reality visualization embarkation system for a user to pack a container including a plurality of objects, the system comprising: a Light Detection and Ranging (LiDAR) scanner configured to scan objects of an equipment set to be packed into the container and generating a digital twin of each scanned object; a digital twin database configured to store the generated digital twin data of each object of the equipment set; an embarkation data file database including embarkation data files required for shipping the equipment set, the embarkation data file including embarkation data associated with the equipment set and digital twin data representations of each of the objects included in the equipment set, the embarkation data file having a format that is useable by a program for manual viewing and manual editing; a 3D bin packing algorithm process configured to provide a packing solution to optimally pack all the objects of the equipment set in one or more customizable container configurations, the packing solution including the location of each object in the one or more customizable container configurations which 1) maximizes a number of objects packed within the one or more customizable container configurations and/or 2) maximizes a number of priority objects packed within the one or more customizable container configurations, the number of priority objects less than a total number of objects included in the equipment set, and the 3D bin packing algorithm process loads the embarkation data files and associated digital twin data representations onto a network server or stand-alone computer; and an augmented reality (AR) computer tablet and/or AR headset configured for a user to access the embarkation data files and associated digital twin data representations to perform a digital pack out of the associated equipment set, wherein the user views and modifies, if necessary, a 3 dimensional (3D) map of the location of each object of the equipment set within the container, and the augmented reality (AR) computer tablet and/or AR headset configured for the user to export to the embarkation system a final 3D map of the location of each object of the equipment set within the container and exporting any modified embarkation data files and any modified associated digital twin data representations to the embarkation file database and digital twin database, respectively.

In accordance with another example embodiment of the present disclosure, disclosed is a 3D augmented reality visualization embarkation system for a user to pack a plurality of containers, each container including a plurality of objects, the system comprising: a bin packing module to provide a user with a building object load plan for each container; a Light Detection and Ranging (LiDAR) Scanner to determine a size of each container, generate digital twins of the plurality of objects, and determine a physical space of an interior of the corresponding container as the equipment is positioned within the interior; a digital twin database to store the digital twins of the plurality of objects; a digital twin module renderer to generate 3D renderings of the digital twins of the plurality of objects; a tracking module to track the digital twins and the corresponding equipment within an augment reality environment; and a measurement module to measure and capture dimensions of the plurality of containers and the objects placed within the plurality of containers.

### BRIEF DESCRIPTION OF THE DRAWINGS

For a more complete understanding of the present disclosure, reference is now made to the following descriptions taken in conjunction with the accompanying drawings.

FIG. 1 shows a method and system for generating embarkation files used by a 3D augmented reality visualization embarkation system for a user to pack a container including a plurality of objects according to an example embodiment of this disclosure.

FIG. 2 shows further details of the method and system of FIG. 1 for generating embarkation files used by a 3D augmented reality visualization embarkation system for a user to pack a container including a plurality of objects according to an example embodiment of this disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Mobility of groups of personnel and their equipment can be difficult, especially when required within a short time frame. For example, when a military unit is put on standby to deploy within an unknown period of time. In the current construct, Marines and Sailors must physically pack all their equipment prior to deployment to determine if it all fits in a box. Across industries augmented reality (AR) is leveraged to streamline packing procedures to determine fit and function. This disclosure, and the example embarkation augmented reality methods and systems disclosed, allow commanders to leave their Marines in the field and simultaneously conduct a digital pack-out while Marines continue to train. Users of the system can validate their embark data with digital twins and then create a digital map of where all their equipment needs to be packed for a smoother physical pack-out. In addition, bin-packing artificial intelligence (AI) software is configured to optimize packing procedures to further streamline operations. If there is a shift in mission or mobility assets, the bin-packing software helps realign equipment sets with new packing lists, embarkation documentation, and a digital map of where the equipment should be placed.

By comparison, conventional embarkation methods involve units packing and repacking their equipment until they run out of time and discard equipment, or they happen to fit everything they need to deploy and operate. There has been little done to solve the embarkation problem described above. Currently, containers are given serial numbers and tracked using different variants of spread sheets and embarkation software. Standard department of defense packing lists are used to capture what is in those containers. There are other embarkation databases that contain the dimensions of a unit's equipment. However, those dimensions are typically incorrect and need to be manually adjusted as new equipment is added to the inventory.

To address the embarkation problems addressed herein, AR, networking, Light Detection and Ranging (LiDAR), and bin-packing technologies are integrated to assist packers, such as Marine units in embarkation operations. Units generate or choose from basic digital twins (i.e., twins with a visual depiction that contains physical dimensions), and then pack those digital twins into containers in preparation for movement. Once packed, the files for each container are saved and exported to a database. Those files, such as csv files, are uploaded manually or automatically into embarkation data bases to be sent to higher headquarters. The 3D digital files are then used at the unit level as a map for their physical equipment pack out.

According to an example embodiment, the operation of the disclosed embarkation augmented reality system includes a menu box which is presented when a user shows an augmented reality (AR) headset the palm of their hand. The user will then be able to select options to build a packing list, upload a packing list, work on an already existing packing list, or export a packing list. The system includes preloaded standard objects for packing (e.g., pelican cases, comm boxes, weapons crates, etc.) and a module for the user to enter dimensions for a new object that can be created and saved in a unit's file.

To pack a container, the user will grab the virtual objects and place them inside of a virtual shipping container. The embarkation system then attempts to stack them evenly. If an object does not fit and collides with another object or the container, the user of the system is notified of the colliding objects, for example by red highlighting. Once all the equipment from a packing list have been virtually loaded, the parent packing container shows the weight for itself, and all the children objects packed inside. A file will be created, saved, and associated to that packing list for future operations and after-action reports. Once the container is packed with the physical equipment the weight of the container is updated in the system and used for future pack-outs.

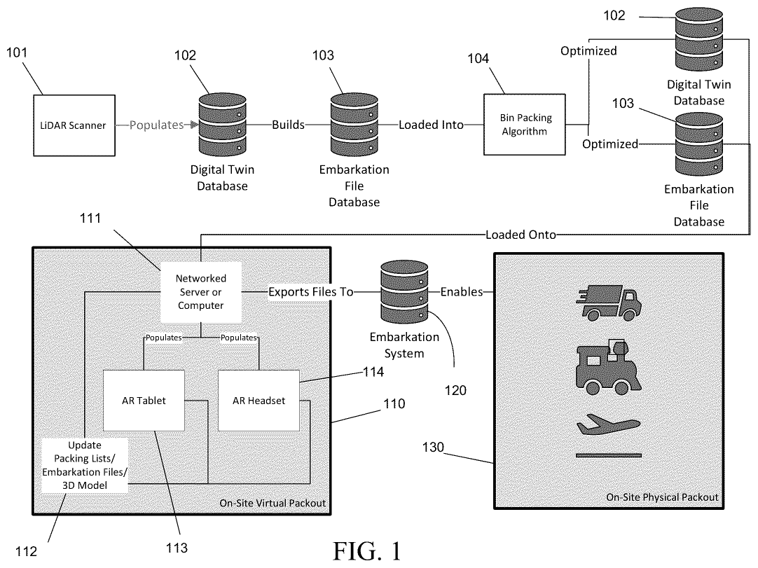

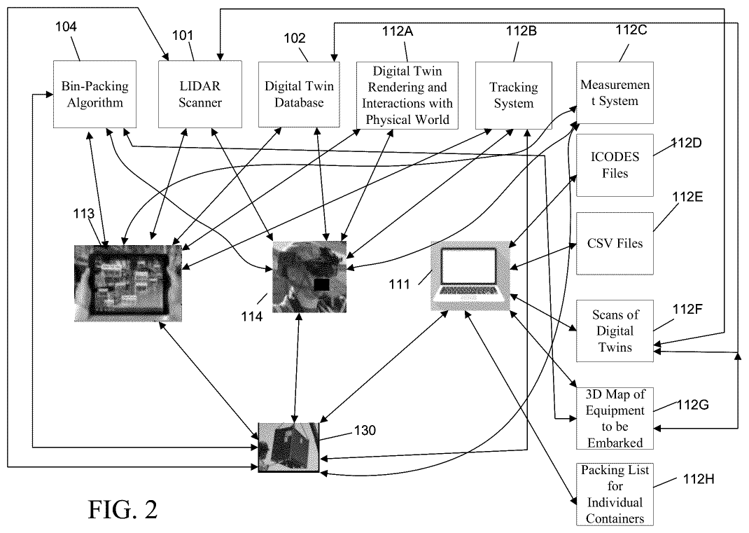

With reference to FIGS. 1 and 2, shown is a method and system for generating embarkation files used by a 3D augmented reality visualization embarkation system for a user to pack a container including a plurality of objects according to an example embodiment of this disclosure.

According to the example embodiment shown and further described herein, provided is a method and system of generating embarkation files used by a 3D augmented reality visualization embarkation system for a user to pack a container including a plurality of objects, the method and system including:
1) a Light Detection and Ranging (LiDAR) scanner, scanning objects of an equipment set to be packed into the container and generating a digital twin of each scanned object; 2) storing in a digital twin database the generated digital twin data of each object of the equipment set; 3) generating an embarkation data file including embarkation data required for shipping the equipment set, the embarkation data file including embarkation data associated with the equipment set and digital twin data representations of each of the objects included in the equipment set, the embarkation data file having a format that is useable by a program for manual viewing and manual editing; 4) processing the embarkation data file using a 3D bin packing algorithm configured to provide a packing solution to optimally pack all the objects of the equipment set in one or more customizable container configurations, the packing solution including the location of each object in the one or more customizable container configurations which 1) maximizes a number of objects packed within the one or more customizable container configurations and/or 2) maximizes a number of priority objects packed within the one or more customizable container configurations, the number of priority objects less than a total number of objects included in the equipment set; 5) loading the embarkation data files and associated digital twin data representations onto a network server or stand-alone computer; 6) using an augmented reality (AR) computer tablet and/or AR headset, a user accessing the embarkation data files and associated digital twin data representations to perform a digital pack out of the associated equipment set, wherein the user views and modifies, if necessary, a 3 dimensional (3D) map of the location of each object of the equipment set within the container; and 7) the user exporting to the embarkation system a final 3D map of the location of each object of the equipment set within the container and exporting any modified embarkation data files and any modified associated digital twin data representations to the embarkation file database and digital twin database, respectively.

As shown in FIG. 1, the system includes an AR headset 114, computer tablet 113, and software running on a computer 111. Users or packers are able to scan and load digital twins of their equipment density list (EDL) using a LiDAR scanner 101 which stores digital twins of the equipment, i.e. objects, in a digital twin database 102. They are then able to load physical containers with their digital equipment. The digital twins are anchored in reality to show the user how to pack their equipment using the headset 114 or computer tablet on a stand pointing at a container. A digital map including the digital twins of the equipment and their location within a container is saved and paired with a packing list for future operations and/or training.

Embarkation augmented reality methods and systems workflow:
Step 1—LiDAR Scanner 101: A LiDAR scanner 101 is used to scan a unit's equipment set. Each object scan is sent to a digital twin database. The LiDAR scanner is used to determine size of a packing container and to generate digital twins of the equipment that needs to be packed. The LiDAR scanner 101 is also used to determine the physical space of the inside of the packing container as equipment is packed.
Step 2—Digital Twin Database 102: The digital twin database 102 is used to compile the equipment set for packing. Users can update the object parametric data associated with the equipment list and associated container as required. According to an example embodiment, the embarkation system communicates with other equipment databases which provide measurement data associated with some or all of the equipment, providing users with the ability to select a digital twin of objects without having to scan every object.
Step 3—Embarkation File Database 103: An embarkation file database 103 contains all of the data required for the shipping of an object (equipment) in a human readable form. This allows the users to scrub the data for accuracy and queries. Files are exportable to multiple file formats depending on the need, including but not limited to CSV files, etc.
Step 4—Bin Packing Algorithm 104: A 3D bin packing algorithm enables a unit to pack all their equipment into their appropriate containers with an optimal load out. The bin packing algorithm 104 optimizes using multiple parameters to include container allocation, prioritization, shipping destination, etc., thereby assisting personnel with the building load plans for each container.
Step 5—Embarkation File/Digital Twin Database: The bin packing algorithm 104 provides the optimal packing solution to a customizable container configuration based on user parameters. The optimized packing solution is loaded into both the embarkation file database 103 and the digital twin database 102.
Step 6—Onsite Virtual Packing 110: The digital twin database and embarkation file database is either loaded onto a networked server 111 that can be accessed from a packing location or loaded on a stand-alone computer acting as a server 111. The server/computer 111 then sends the digital twin data to the AR tablet 113 and/or AR headset 114. The packers are able to choose the container they wish to pack digitally and the packing list for that container is provided to them. If needed, the packers are able to make adjustments to the 3D map (representation of packed equipment) 112. Any adjustments are fed back to the server/computer 111 with updated 3D models, embarkation files, and packing lists.
Step 7—Export Embarkation Files: Once the pack out is complete, the files are exported in the appropriate file formats required for the embarkation system 120. Packing lists can then be printed and adhered to the containers as required.
Step 8—On-site Physical Packing 130: When a unit prepares to pack their physical equipment, they will already have a 3D digital twin of where and how their equipment should be packed. The AR tablet 113 can be set on a stand in front of the container to provide a visualization to the packers and leadership. The AR Headsets 114 are used by the embarkation personnel guiding the pack out and also identify if the containers are being packed optimally through a 3D AR visualization.

With reference to FIG. 2, shown are further details of the method and system of FIG. 1 for generating embarkation files used by a 3D augmented reality visualization embarkation system for a user to pack a container including a plurality of objects according to an example embodiment of this disclosure. FIG. 2 shows the communication channels between the various processes previously described with reference to FIG. 1, as well as showing modules or processes running on the networked server or computer 111 or other computer, including: 1) Digital Twin Rendering and Interactions with Physical World 112A; The LiDAR scanner is used to capture the dimensions of an object and create a digital twin of said object. The user then uses the digital twin of the object to execute a digital pack out. 2) Tracking System 112B: The AR devices (headset or tablet) are configured to track digital and physical objects as they are moved around and tag different objects to move them around; 3) Measurement System 112C: The system is configured to measure and capture the dimensions of both the packaging container and the equipment being packed; 4) Exporting of ICODES Files 112D and CSV files 112E; 5) Scans of Digital Twins 112F; 6) 3D Map of Equipment to be Embarked 112G; and 7) Packing List generation for Individual Containers 112H.

To enhance the capability of the system, the embarkation method and system is configured to interact/communicate with other mobility and logistics software. This can be accomplished using standard data sets (i.e. csv) that aligns with data sets required for embarkation (i.e. ICODES, MDSS II, JOPES, etc.).

As the user packs the container with digital twins, a 3D map of embarked equipment is saved to allow the user to recreate their pack out with physical objects at a future time. To embark a container, each container requires a packing list. Once the digital pack has been completed, the system will export a packing list with all equipment in the container.

Some example commercially available components/subcomponents, according to an example embodiment of this disclosure, can include the following:
1) LiDAR Scanner 101: VARJO lidar virtual reality (VR) headset and LEICA BLK2GO scanner;
2) 3D Bin Packing Algorithms based on DEEPPACK.AI;
3) AR Tablet; SAMSUNG GALAXY and APPLE IPAD PRO; and
4) AR Headset: MAGIC LEAP 2; HALOLENS and APPLE VISION PRO.

Some additional features of the included components and systems include the following: 1) 8 hours of continued use with single battery or interchangeable batteries; 2) Articulated Hand tracking; 3) Voice commands; 4) Spatial mapping; 5) Network or standalone capable; 6) See through holographic lenses; 7) Object Manipulation; 8) at a System-Level, Interaction with Integrated Computerized Deployment System (ICODES); 9) Cloud based databases for storing all files; 10) Wifi 5 or greater, Bluetooth 5 or greater, USB communication capabilities; 11) Display Solutions: Head mounted display and See through holographic display; 12) Interaction Modalities (Object Manipulation); 12.1) Selection Techniques including List selection, Voice input, and Point or grab at virtual object; 12.2) Manipulation Techniques including Attach to hand, User object scaling, 1-to-1 hand to object motion and rotation Graphical feedback, Release, Gesture and Object remains in final location; 13) The AR Headset is capable of pulling 3d digital twins from a database and rendering them in an accurate size and anchoring them in the physical world; 14) A computer application can show a representation of a packing map and generate digital twins by manually inputting dimensions; 15) The functions of the AR headset is replicated on a computer tablet; 16) The AR headset, computer, and tablet are all networked to each other and the cloud to more efficiently build digital twins, generate packing maps, and export data to embarkation programs; and 17) AI bin-packing software is fully integrated to all hardware devices and can optimize a pack out at the battalion level.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. A method of generating embarkation files used by a 3D augmented reality visualization embarkation system for a user to pack a container including a plurality of objects, the method comprising:
using a Light Detection and Ranging (LiDAR) scanner, scanning objects of an equipment set to be packed into the container and generating a digital twin of each scanned object;
storing in a digital twin database the generated digital twin data of each object of the equipment set;
generating an embarkation data file including embarkation data required for shipping the equipment set, the embarkation data file including embarkation data associated with the equipment set and digital twin data representations of each of the objects included in the equipment set, the embarkation data file having a format that is useable by a program for manual viewing and manual editing;
processing the embarkation data file using a 3D bin packing algorithm configured to provide a packing solution to optimally pack all the objects of the equipment set in one or more customizable container configurations, the packing solution including the location of each object in the one or more customizable container configurations which 1) maximizes a number of objects packed within the one or more customizable container configurations and/or 2) maximizes a number of priority objects packed within the one or more customizable container configurations, the number of priority objects less than a total number of objects included in the equipment set;
loading the embarkation data files and associated digital twin data representations onto a network server or stand-alone computer;
using an augmented reality (AR) tablet and/or AR headset, a user accessing the embarkation data files and associated digital twin data representations to perform a digital pack out of the associated equipment set, wherein the user views and modifies, if necessary, a 3 dimensional (3D) map of the location of each object of the equipment set within the container; and
the user exporting to the embarkation system a final 3D map of the location of each object of the equipment set within the container and exporting any modified embarkation data files and any modified associated digital twin data representations to the embarkation file database and digital twin database, respectively.

2. The method of claim 1, wherein a packer uses a rendering of the final 3d map of the location of each object of the equipment set within the container to pack the equipment set with the container.

3. The method of claim 1, wherein the embarkation system retrieves a digital twin of one or more of the objects from the digital twin database which are provided by another external process.

4. The method of claim 1, wherein the plurality of objects are one or more of pieces of equipment, and bins including pieces of equipment and/or provisions.

5. The method of claim 1, wherein the LiDAR scanner identifies one or more of the plurality of objects and the embarkation system retrieves a digital twin of the identified one or more objects from the digital twin database.

6. The method of claim 1, further comprising:
generating printed packing lists based on the final 3D map of the location of each object of the equipment set within the container and the embarkation data files, the packing lists adhered to the container and accessible to a packer of the container.

7. The method of claim 1, wherein a packer uses a rendering of the final 3D map of the location of each object of the equipment set within the container to pack the equipment set with the container, and the embarkation system is configured to provide a visualization to the packer using the AR computer tablet and/or AR headset to provide an overlay of the final 3D map of the location of each object and an indication of the physical placement of objects within the container as they are packed, relative to a desired location of each object as indicated by the final 3D map of the location of each object.

8. The method of claim 7, wherein if an object collides with another object or the container at the desired location, the colliding objects are visually marked within the visualization provided to the packer for further actions by the packer, including modification of the digital twin of the colliding objects.

9. A 3D augmented reality visualization embarkation system for a user to pack a container including a plurality of objects, the system comprising:
a Light Detection and Ranging (LiDAR) scanner configured to scan objects of an equipment set to be packed into the container and generating a digital twin of each scanned object;
a digital twin database configured to store the generated digital twin data of each object of the equipment set;
an embarkation data file database including embarkation data files required for shipping the equipment set, the embarkation data file including embarkation data associated with the equipment set and digital twin data representations of each of the objects included in the equipment set, the embarkation data file having a format that is useable by a program for manual viewing and manual editing;
a 3D bin packing algorithm process configured to provide a packing solution to optimally pack all the objects of the equipment set in one or more customizable container configurations, the packing solution including the location of each object in the one or more customizable container configurations which 1) maximizes a number of objects packed within the one or more customizable container configurations and/or 2) maximizes a number of priority objects packed within the one or more customizable container configurations, the number of priority objects less than a total number of objects included in the equipment set, and the 3D bin packing algorithm process loads the embarkation data files and associated digital twin data representations onto a network server or stand-alone computer; and
an augmented reality (AR) computer tablet and/or AR headset configured for a user to access the embarkation data files and associated digital twin data representations to perform a digital pack out of the associated equipment set, wherein the user views and modifies, if necessary, a 3 dimensional (3D) map of the location of each object of the equipment set within the container, and the augmented reality (AR) computer tablet and/or AR headset configured for the user to export to the embarkation system a final 3D map of the location of each object of the equipment set within the container and exporting any modified embarkation data files and any modified associated digital twin data representations to the embarkation file database and digital twin database, respectively.

10. The system of claim 9, wherein a packer uses a rendering of the final 3d map of the location of each object of the equipment set within the container to pack the equipment set with the container.

11. The system of claim 9, wherein the embarkation system retrieves a digital twin of one or more of the objects from the digital twin database which are provided by another external process.

12. The system of claim 10, wherein the plurality of objects are one or more of pieces of equipment, and bins including pieces of equipment and/or provisions.

13. The system of claim 10, wherein the LiDAR scanner identifies one or more of the plurality of objects and the embarkation system retrieves a digital twin of the identified one or more objects from the digital twin database.

14. The system of claim 10, generating printed packing lists based on the final 3D map of the location of each object of the equipment set within the container and the embarkation data files, the packing lists adhered to the container and accessible to a packer of the container.

15. The system of claim 10, wherein a packer uses a rendering of the final 3D map of the location of each object of the equipment set within the container to pack the equipment set with the container, and the embarkation system is configured to provide a visualization to the packer using the AR computer tablet and/or AR headset to provide an overlay of the final 3D map of the location of each object and an indication of the physical placement of objects within the container as they are packed, relative to a desired location of each object as indicated by the final 3D map of the location of each object.

16. The system of claim 15, wherein if an object collides with another object or the container at the desired location, the colliding objects are visually marked within the visualization provided to the packer for further actions by the packer, including modification of the digital twin of the colliding objects.

17. A 3D augmented reality visualization embarkation system for a user to pack a plurality of containers, each container including a plurality of objects, the system comprising:
a bin packing module to provide a user with a building object load plan for each container;
a Light Detection and Ranging (LiDAR) Scanner to determine a size of each container, generate digital twins of the plurality of objects, and determine a physical space of an interior of the corresponding container as the equipment is positioned within the interior;
a digital twin database to store the digital twins of the plurality of objects;
a digital twin module renderer to generate 3D renderings of the digital twins of the plurality of objects;
a tracking module to track the digital twins and the corresponding equipment within an augment reality environment; and
a measurement module to measure and capture dimensions of the plurality of containers and the objects placed within the plurality of containers.

18. The system of claim 17, further comprising:
an interface module to obtain logistics data from a third party logistics application,
wherein the logistics data includes digital twin data representative of one or more of digital twins of the objects and/or plurality of containers.

19. The system of claim 17, wherein the tracking module is configured to generate a packing list for the objects in a corresponding container after a user has designated the corresponding container as ready for embarkment.

20. The system of claim 17,
wherein a packer uses a rendering of the final 3D map of the location of each object of the equipment set within the container to pack the equipment set with the container, and the embarkation system is configured to provide a visualization to the packer using the AR computer tablet and/or AR headset to provide an overlay of the final 3D map of the location of each object and an indication of the physical placement of objects within the container as they are packed, relative to a desired location of each object as indicated by the final 3D map of the location of each object, and
wherein if an object collides with another object or the container at the desired location, the colliding objects are visually marked within the visualization provided to the packer for further actions by the packer, including modification of the digital twin of the colliding objects.
